(19) United States
(12) Patent Application Publication
(10) Pub. No.: US 2015/0110946 A1
(43) Pub. Date: Apr. 23, 2015

(54) Collapsible Foodstuff Packaging and Method of Mixing Added Condiments

(71) Applicant: Mitchell Casimir Dyderski, Whitmore Lake, MI (US)

(72) Inventor: Mitchell Casimir Dyderski, Whitmore Lake, MI (US)

(21) Appl. No.: 14/058,482

(22) Filed: Oct. 21, 2013

(51) Int. Cl. B65D 21/08; A23L 1/221

(52) U.S. Cl. CPC B65D 21/086; A23L 1/221; A23V 2002/00
USPC 426/650; 220/666

(57) ABSTRACT

A collapsible foodstuff package comprising a collapsible lower part and a collapsible cover. The collapsible lower part including an enclosed wall (or walls), an open end, and a bottom structure. The collapsible cover including an enclosed wall (or walls), an open end, and a closed top structure. The collapsible cover can be integrally attached or removably attached to the lower part of the collapsible package. The collapsible cover can be positioned so that its wall (or walls) overlap the lower part of the collapsible package. The enclosed wall (or walls) of the collapsible cover are of a predetermined length so as to increase the volume within the collapsible package thereby providing a space wherein the foodstuff and subsequently added condiments can be easily shaken thus allowing dispersal and mixing of the condiments and foodstuff without allowing spillage of the packages contents.

### CROSS REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to collapsible packaging, in particular, collapsible packaging in which a foodstuff is placed and a condiment is then added to impart flavoring. The collapsible packaging allows for the condiment to be dispersed/mixed within the foodstuff by the method of shaking the packaging.

2. Prior Art

It is common for foodstuffs such as popcorn, chips, peanuts, pretzel bites, among others to be served in various packaging at many venues. It is also a well known problem that when such foodstuffs are placed in the typical open-ended packaging offered at these venues, the condiments are typically added to the top portion of the foodstuffs without adequate dispersal of the condiments. When dispersal and mixing of the condiments is attempted a mess usually is the result as the foodstuff and condiments are shaken out of the open packaging with minimal dispersal of the condiments and frustrated consumers.

The most common packaging used in many venues that serve foodstuffs is a paper constructed package with one end being open for the placement of the foodstuff. Typically the foodstuff is placed into the package and filled to the top of the package where it offers a visually appealing product to the consumer. There are many types of packaging proposed for foodstuffs in prior art. Some prior art shows the addition of various features to the packaging, such as pockets on the package for inserting other products such as hand wipes or candy. There is also prior art depicting the various closure systems that can be added to packaging for resealing the package for future use. Still other prior art shows the various construction of the packaging to facilitate manufacturing or impart specific qualities to the package. There are not many prior art examples that specifically show packaging that adequately addresses the problems associated with adding foodstuffs to a package and subsequently adding and dispersing/mixing condiments to the package of foodstuff. Prior art discloses the various descriptions for various packaging and their functionality.

U.S. Patent application publication No. 20130108753 by Thomas discloses a tubiform bag with a first and second closable opening at both end in which the foodstuffs and condiments can be placed at either end to facilitate the dispersal of condiments within the package containing foodstuffs.
U.S. Patent application publication No. 20070269573 by Absher and Boyer discloses an attachment for a popcorn serving container which increases the volume of the serving container to facilitate distribution of a condiment through popcorn kernels via agitation of the kernels without spilling.
U.S. Pat. No. 2,815,164 issued to Painter discloses an improvement in an open ended popcorn box that is strengthened by it unique folded construction that also allows the box to be used to scoop popcorn
U.S. Pat. No. 3,784,087 issued to Styers discloses a bag or carton with a re-sealable closure comprising a deformable wire within an envelope formed by a folder over portion of the package at it opening.
U.S. Pat. No. 781,821 issued to Glenwright discloses fastening means for a paper bag containing a gathering string within a pocked formed by a strip pasted to the perimeter of the bag wherein the bag can be closed and secured.
U.S. Pat. No. 1,903,839 issued to Royal discloses a means for folding and retaining in the closed position a paper bag comprising one or more vertical wires secured to the bag.
U.S. Pat. No. 3,578,236 issued to Masayuki discloses a rectangular paper bag with flexible reinforcement wire along the open top edges wherein the bag can be retained in the open or closed positions.
U.S. Pat. No. 3,669,254 issued to Chrysanthis et al discloses a paper bag with pressure sensitive adhesive along the open top edges wherein the bag can be retained in the closed position.
U.S. Pat. No. 6,030,652 issued to Hanus discloses a bag with product access opening including two gusset panels and a product access opening between the two panels that can be resealed closed.
U.S. Pat. No. 1,433,439 issued to Weis discloses a paper box or similar container made of a single blank of paper with foldably connected sections to form the side walls and flaps to form the top and the bottom.
U.S. Pat. No. 7,984,842 issued to Richie discloses a megaphone popcorn cup with an overlapping side wall and generally conical shape. One end being smaller than the other with friction fit covers to be removed after the consuming of the popcorn.
U.S. Pat. No. 8,016,485 issued to McCann discloses a collapsible container for holding popcorn featuring side pockets, handles and a resealable opening
U.S. Patent application publication No. 20110002558 by Sargin discloses a hooded bag with re-closable top. The bag opening is held closed by 2 fasteners and covered by a hood to resist tampering of the product within the bag.

Although there have been many proposals for various types of packaging throughout the years, much of this prior art is rather limited in functionality, such as the various type of closure systems proposed so as to secure the contents of the package. Many others pertain to the construction of the package so that it retains specific qualities such as moisture retention or ease of manufacture. There are not many examples of prior art that address the specific issue of adding and distributing/mixing condiments to the contents of the package. Those that have been proposed have not been successful in the market, possibly due to awkward design, inconvenient functionality, or possibly in the difficulty to manufacture such a package at a reasonable cost. Yet their seems to be a lack of a viable solution that address the problem of adding and distributing/mixing condiments to a package of foodstuffs that are normally served at venues such as fairs, sporting events, the movies, etc. . . . One need to look no further than the condiment counter at the movie theatre where butter and various flavored products are added to the popcorn sold there. The counter is usually covered with spilled popcorn and flavorings and requires constant cleaning by the movie attendants who work there. The patrons must also return frequently to re-flavor the popcorn once the flavored top portion is eaten, adding to their inconvenience.

The object of the described embodiments of the invention is to provide a viable, practical, and simple packaging solution that allows for the condiments that have been added to the foodstuffs to be distributed/mixed throughout the foodstuff by allowing the foodstuff/condiment mixture to be easily shaken without allowing spillage of the packages contents. The proposed packaging still offers a visually appealing product to the consumer which can also be economically manufactured as well as collapsed flat for ease of shipping and storage.

### SUMMARY

A collapsible foodstuff package for the placement of foodstuff and subsequent addition of condiments that allows for the dispersal/mixing of the condiments to the packaged foodstuff. The collapsible package has a means of increasing the volume of the package to facilitate in the distribution of condiments in the foodstuff via agitation of the package without spilling the contained mixture of foodstuff and condiments. The collapsible package comprises a collapsible lower part including an enclosed wall (or walls) that can be of various shapes, an open end, and further including a bottom structure that can be closed while being manufactured or during manual assembly of the package. When unfolded, the collapsible lower part allows for the placement of the foodstuff and subsequent addition of condiments. The open end portion of the collapsible lower part of the package includes a collapsible cover. The collapsible cover including an enclosed wall (or walls) of a predetermined shape, an open end, and further including a closed top structure which can be closed while being manufactured or during manual assembly of the package. The collapsible cover can be integrally attached or removably attached to the lower part of the collapsible package, wherein the collapsible cover can or be placed into a position so that its wall (or walls) can encase the lower part of the package by overlapping the lower part of the package. The enclosed wall (or walls) of the collapsible cover are of sufficient length that when it overlaps the lower part of the collapsible package, the volume within the collapsible package is increased thereby providing a space wherein the foodstuff and subsequently added condiments can be easily shaken thus allowing dispersal and mixing of the condiments and foodstuff without allowing spillage of the packages contents. The collapsible foodstuff package proposed can be made manufactured from a variety of flexible materials currently used in packaging, such as the various paper-constructed or laminated paper products, as well as the multitude of plastic materials. The collapsible foodstuff package can also be manufactured by the typical manufacturing processes used in making packaging.

### DRAWINGS

### Figures

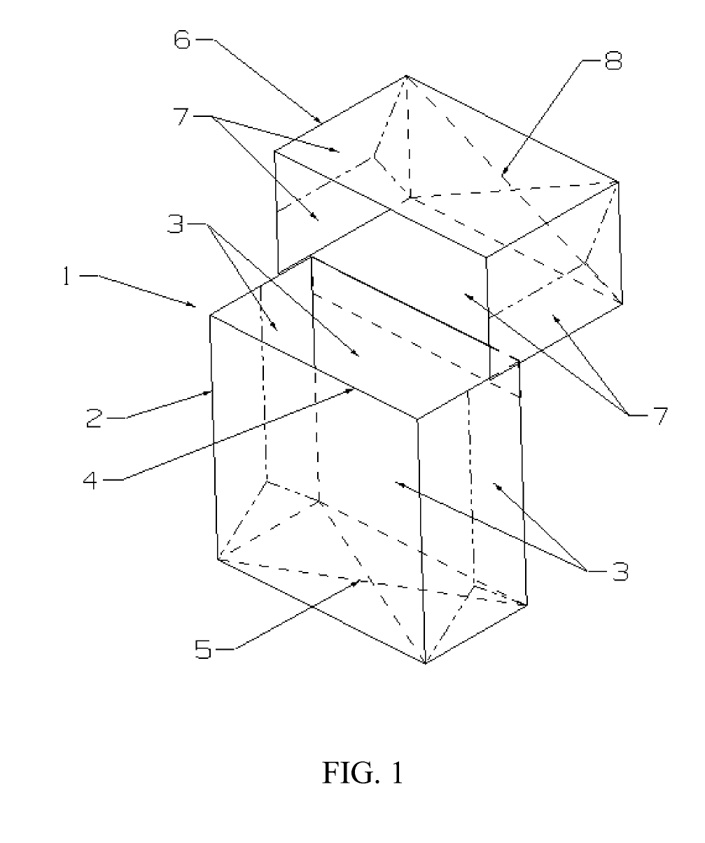

FIG. 1 is an isometric view of a rectangular shaped collapsible foodstuff package.

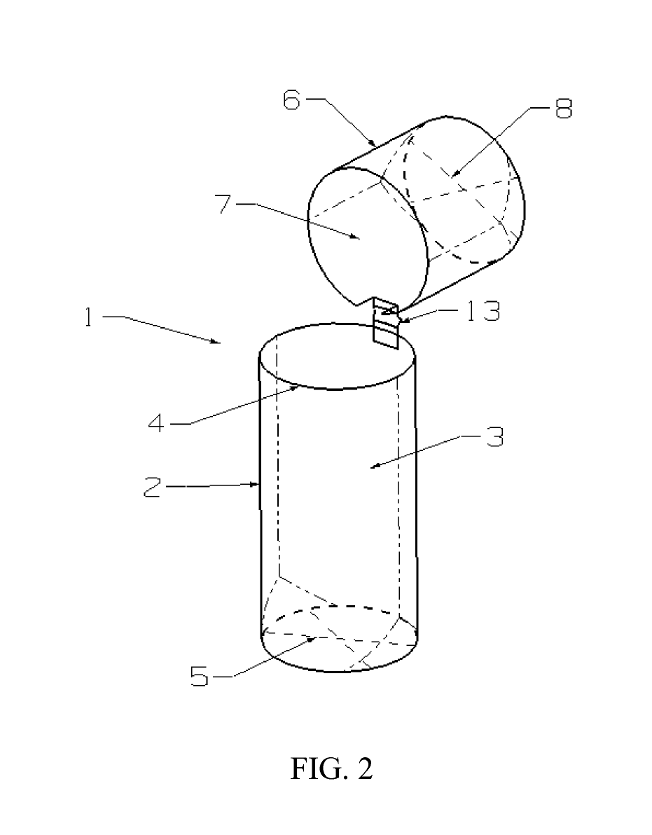

FIG. 2 is an isometric view of an oval shaped collapsible foodstuff package.

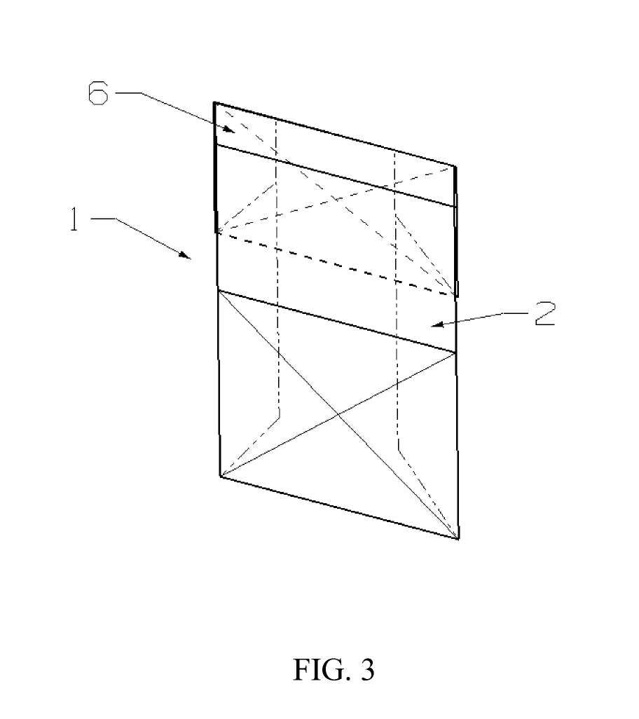

FIG. 3 is an isometric view of a rectangular shaped collapsible foodstuff package in a collapsed state.

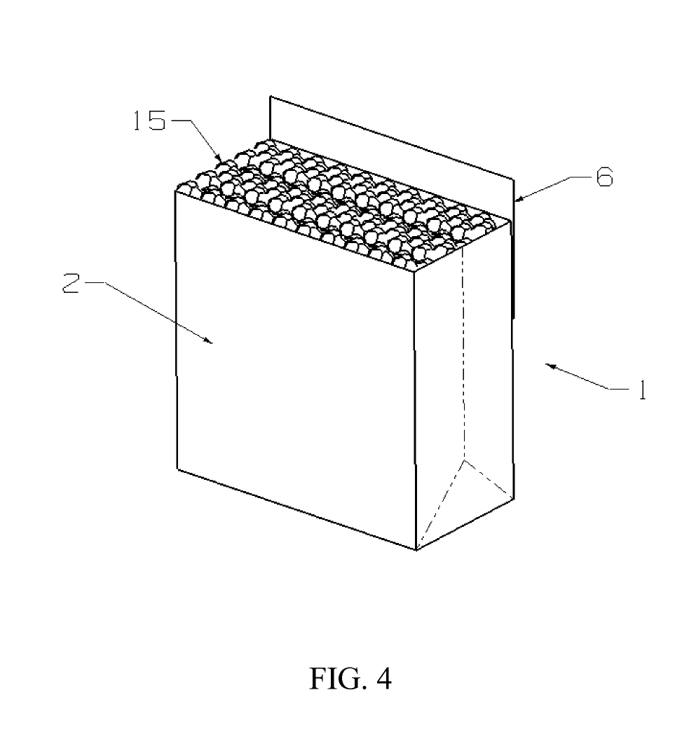

FIG. 4 is an isometric view of a rectangular shaped collapsible foodstuff package filled with foodstuff and the collapsible cover portion in a collapsed state.

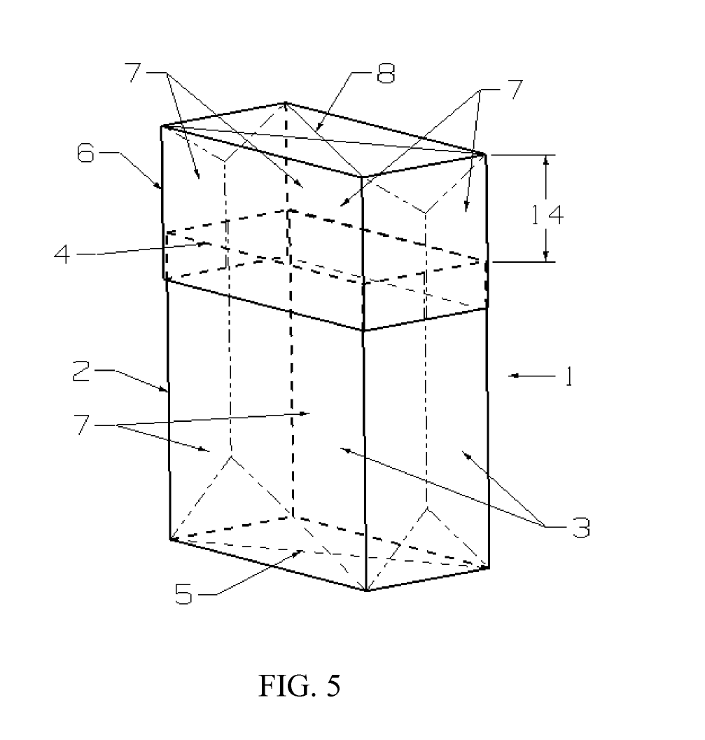

FIG. 5 is an isometric view of the top cover portion of a rectangular shaped collapsible foodstuff package showing the overlapping feature of the walls.

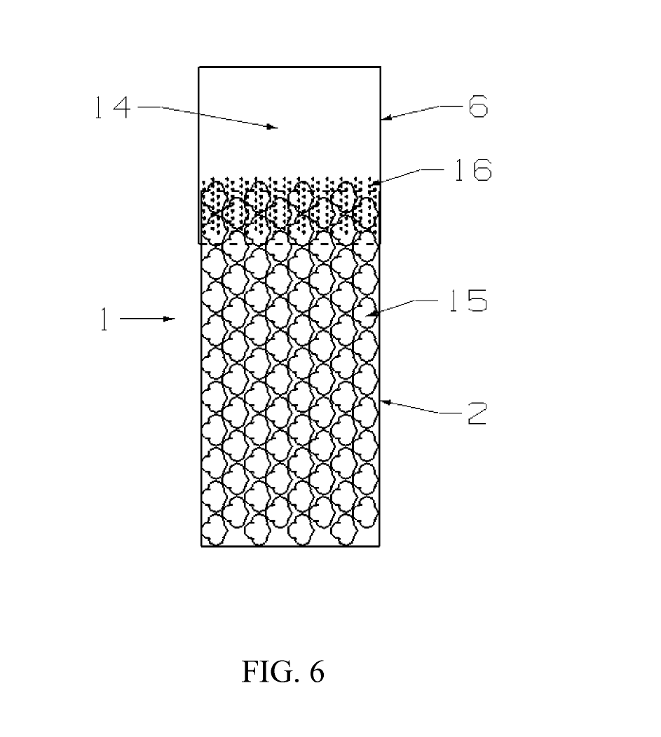

FIG. 6 is section view of a collapsible foodstuff package in which the foodstuff and condiments have been placed and the collapsible cover portion of the package positioned to encase the lower portion of the package.

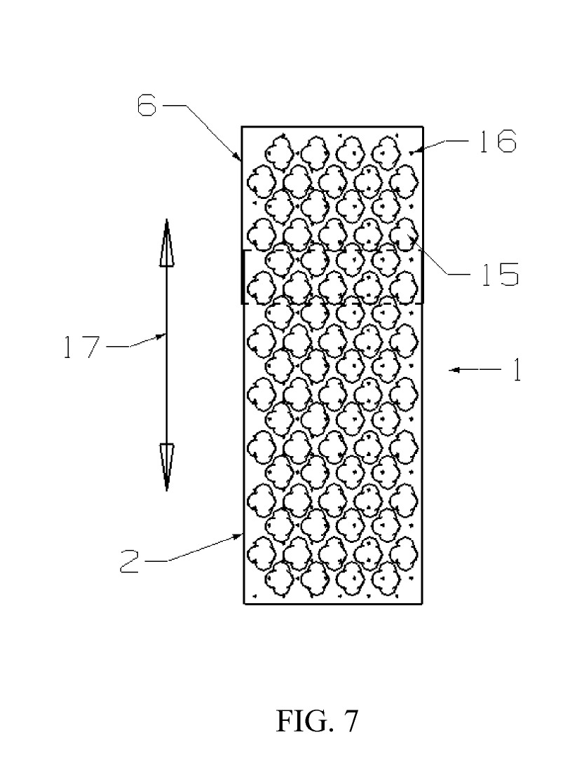

FIG. 7 is a section view depicting the shaking method used to mix the foodstuff and condiments utilizing the collapsible foodstuff package.

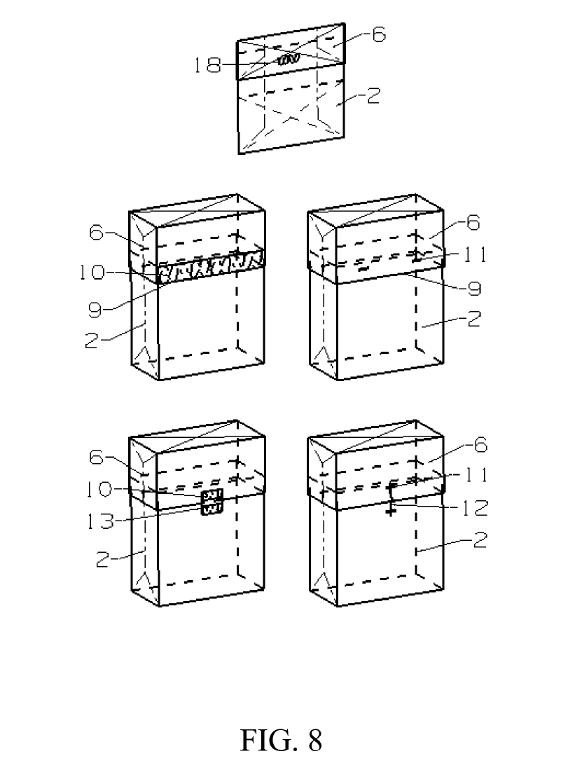

FIG. 8 is a view showing the various means of attaching the collapsible cover to the collapsible lower part of the collapsible foodstuff package.

### DETAILED DESCRIPTION

### Preferred Embodiments—FIGS. 1-7

Referencing the drawings contained herein, the corresponding parts being identified numerically the same as those in the following description. FIG. 1, FIG. 2, FIG. 3, FIG. 4, FIG. 5, FIG. 6, FIG. 7, FIG. 8, show the collapsible foodstuff package and method to aid in the mixing of added condiments as well as all the features described below.

A collapsible package 1 for the placement of foodstuff and subsequent addition of condiments including a collapsible lower part 2 having an enclosed wall (or walls) 3 that can be of various shapes, including an open end portion 4 and a bottom structure 5 that can be closed while being manufactured or during manual assembly of the package. The open end portion 4 of the collapsible lower part 2 of the collapsible package 1 further including a collapsible cover 6 with an enclosed wall (or walls) 7 of similar shape as the collapsible lower part 2 of the collapsible package 1 and a closed top structure 8 which can be closed while being manufactured or during manual assembly of the collapsible package 1. The collapsible cover 6 of the collapsible package 1 being integrally attached to the collapsible lower part 2 of the collapsible package 1. The means of being integrally attached may include a portion 9 of the collapsible cover 6 being attached to the collapsible lower part 2 by an adhesive 10 or at least one staple 11. Another means of being integrally attached may include the collapsible cover 6 being attached to the collapsible lower 2 part by at least one chord 12, or at least one strip of flexible material 13. Yet another means of being integrally attached may include the collapsible cover 6 being attached to the collapsible lower part 2 by the forming of the blank stock used in manufacturing the collapsible foodstuff package 1. The collapsible cover 6 can be placed into a position so that its wall (or walls) 7 can encase the collapsible lower part 2 of the collapsible package 1 by overlapping the open end portion 4 of the collapsible lower part 2 of the collapsible package 1. The enclosed wall (or walls) 7 of the collapsible cover 6 are of a predetermined length so that when the collapsible cover 6 overlaps the open end portion 4 of the collapsible lower part 2 of the collapsible package 1, a space 14 is created, thus increasing the volume within the collapsible package 1 and providing an area wherein the foodstuff 15 and subsequently added condiments 16 can be easily shaken 17 thus allowing dispersal and mixing of the foodstuff 15 and added condiments 16 without allowing spillage of the collapsible package 1 contents.

Another embodiment of the collapsible package 1 wherein the collapsible cover 6 of the collapsible package 1 has a means of being removably attached to the collapsible lower part 2 of the collapsible package 1. The means of being removably attached may include the collapsible cover 6 being attached to the collapsible lower 2 part by sticky adhesive 18 that allows removal of the collapsible cover 6 from the collapsible lower part 2. The collapsible cover 6 can be detached after adding the foodstuff 15 and subsequently added condiments 16 and placed into a position so that its wall (or walls) 7 can encase the collapsible lower part 2 of the collapsible package 1 by overlapping the open end portion 4 of the collapsible lower part 2 of the collapsible package 1 thereby creating a space 14 and increasing the volume within the collapsible package 1.

The collapsible package 1 can be made manufactured from a variety of flexible materials currently used in packaging, such as the various paper-constructed or laminated paper materials, as well as the multitude of plastic materials. The collapsible foodstuff package can also be manufactured by the typical manufacturing processes used in making packaging.

### Operation

In the embodiments of the collapsible foodstuff package 1, the lower part 2 of the collapsible package 1 is unfolded and the foodstuff 15 is added to the collapsible lower part 2 of the collapsible package 1 and subsequently condiments 16 are added to the foodstuff 15. The a collapsible cover 6 is unfolded and placed into a position so that its wall (or walls) 7 can encase the collapsible lower part 2 of the collapsible package 1 by overlapping the open end portion 4 of the collapsible lower part 2 of the collapsible package 1. The collapsible package 1 is shaken 17 thus allowing dispersal and mixing of the foodstuff 15 and added condiments 16 without allowing spillage of the collapsible package 1 contents.

### Advantages

The object of the described embodiments of the invention is to provide a practical, simple, and economical packaging solution that when filled with foodstuffs, the collapsible package offers a visually appealing product to the consumer. After the condiments have been subsequently added to the foodstuffs, the collapsible cover, once unfolded and placed into a position overlapping the lower part of the collapsible package, increases the volume of the collapsible package. This increase in volume of the package allows for the condiments that have been added to the foodstuffs to be distributed/mixed throughout the foodstuff when the package is shaken without allowing spillage of the packages contents. The proposed packaging can also be economically manufactured out of a variety of materials and can be collapsed flat for ease of shipping and storage.

### CONCLUSIONS, RAMIFICATIONS, AND SCOPE

Thus the reader will see that the simple yet effective design of the collapsible foodstuff packaging as described above has defined advantages in that when it is filled with the various foodstuffs served at the many venues, it offers a visually appealing product to the consumer. The consumer then may add the various condiments to the foodstuffs for added flavoring and utilize the collapsible cover by unfolding and placing the cover into a position overlapping the lower part of the package. This provides for an increased volume of the package thereby aiding in the distribution/mixing of the contents of the package when the package is shaken without allowing spillage of the packages contents. This is an advantage to the venues operators as well in that it improves the consumer experience by minimizing the frustration with the current methods of adding condiments to foodstuff packaging offered at these venues. An added advantage to the venues operators is that improved collapsible foodstuff package would minimizes the mess often found at the condiment counter that requires constant cleaning by the attendants who work there. The proposed packaging can also be economically manufactured out of a variety of materials utilizing manufacturing methods that are common to the packaging industry. The improved collapsible foodstuff package can also be collapsed flat for ease of shipping and storage.

While the above description contains many specifics, these should not be construed as to limiting the scope of the described embodiments, but rather as an example of the preferred embodiments. Thus the scope of the embodiments should be determined by the appended claims and their legal equivalents.

I claim:

1. A collapsible foodstuff packaging made from flexible material comprising of:
a) a collapsible lower part including an enclosed wall (or walls);
b) said collapsible lower part having an open end;
c) said collapsible lower part including a closed bottom structure;
d) said collapsible foodstuff packaging further including a collapsible cover;
e) said collapsible cover including an enclosed wall (or walls);
f) said collapsible cover having an open end;
g) said collapsible cover including a closed top structure;
h) said enclosed wall (or walls) of said collapsible cover comprising a predetermined length whereby increasing the volume of said improved collapsible foodstuff packaging when said open end of said collapsible cover is positioned over said open end of said collapsible lower part;
i) said enclosed wall (or walls) of said collapsible cover further including a predetermined length whereby said open end of said collapsible cover overlaps said open end of said collapsible lower part thus encapsulating the contents of said collapsible foodstuff packaging;
j) said collapsible cover including a means of being integrally attached to said collapsible lower part;

2. A collapsible foodstuff packaging made from flexible material comprising of:
a) a collapsible lower part including an enclosed wall (or walls);
b) said collapsible lower part having an open end;
c) said collapsible lower part including a closed bottom structure;
d) said collapsible foodstuff packaging further including a collapsible cover;
e) said collapsible cover including an enclosed wall (or walls);
f) said collapsible cover baying an open end;
g) said collapsible cover including a closed top structure;
h) said enclosed wall (or walls) of said collapsible cover comprising a predetermined length whereby increasing the volume of said improved collapsible foodstuff packaging when said open end of said collapsible cover is positioned over said open end of said collapsible lower part;
i) said enclosed wall (or walls) of said collapsible cover further including a predetermined length whereby said open end of said collapsible cover overlaps said open end of said collapsible lower part thus encapsulating the contents of said collapsible foodstuff packaging;
j) said collapsible cover including a means of being removably attached to said collapsible lower part;

3. A method of mixing added condiments to foodstuff utilizing a collapsible foodstuff packaging comprising the steps of:
a) preparing a collapsible lower part of said collapsible foodstuff packaging for addition of said foodstuff;
b) filling said collapsible lower part with said foodstuff;
c) adding said condiments to said foodstuff;
d) preparing a collapsible cover for placement over said collapsible lower part;
d) placing said collapsible cover into a position overlapping and encasing said collapsible lower part whereby volume is increased to said collapsible foodstuff packaging;
d) shaking said collapsible foodstuff packaging whereby said foodstuff and said condiments are thoroughly mixed;
